(19) United States
(12) Patent Application Publication
(10) Pub. No.: US 2015/0234891 A1
(43) Pub. Date: Aug. 20, 2015

(54) METHOD AND SYSTEM FOR PROVIDING CODE SCANNING RESULT INFORMATION

(71) Applicant: Alibaba Group Holding Limited, George Town (KY)

(72) Inventor: Shuyan Liu, Hangzhou (CN)

(21) Appl. No.: 14/622,625

(22) Filed: Feb. 13, 2015

(30) Foreign Application Priority Data
Feb. 19, 2014 (CN) 201410056706.X

(51) Int. Cl. G06F 17/30

(52) U.S. Cl. CPC G06F 17/30424; G06F 17/30598; G06F 17/30241

(57) ABSTRACT

Providing code scanning result information includes pre-storing multiple code scanning records in a database, the multiple code scanning records comprising code scanning result information and corresponding geographic location information at times of code scanning actions, receiving a request from a current user to acquire at least some of the code scanning result information, obtaining geographic location information of the current user, acquiring the code scanning result information included in target code scanning records having distances from the geographic location of the current user that are less than a preset geographic distance threshold value, and providing the code scanning result information to the current user.

### CROSS REFERENCE TO OTHER APPLICATIONS

This application claims priority to People's Republic of China Patent Application No. 201410056706.X entitled A METHOD AND A DEVICE FOR PROVIDING CODE SCANNING RESULT INFORMATION, filed Feb. 19, 2014 which is incorporated herein by reference for all purposes.

### FIELD OF THE INVENTION

The present application relates to a method and system for providing code scanning result information.

### BACKGROUND OF THE INVENTION

Due to the development of computer networks and the spread of computer equipment, more users are acquiring various kinds of information and resources through the Internet. In addition, as mobile terminals become smarter and more widespread, a greater number of people are using smart mobile terminals, such as smart phones and tablet computers, to access the Internet and acquire information from the Internet. Smart mobile terminals have good portability and utilize Wi-Fi and mobile networks having ever higher bandwidths. As a result, people can easily access the Internet at any time and any place.

The increase in the quality of the hardware and software of mobile terminal devices has allowed service providers to provide more services. New service models, such as an O2O (Online to Offline) service model, have also arrived. The O2O service model is a service model that combines online with offline. Under such a service model, the Internet serves as a front end for offline services. Information regarding the offline services is provided to users online. By browsing Internet service information, users can obtain offline service information published by service providers and then make on-site purchases at offline places of business or use corresponding services provided by service providers based on the offline service information.

In the O2O service model, the Internet offline service information typically uses graphic codes as an information medium. Examples of the graphic codes include barcodes and Quick Response (QR) codes. A user can scan a barcode on an outer package of a product using an appropriate application installed on a mobile terminal to learn the name and other information of the product and compare the prices of various major sellers for the product. By scanning a QR code provided by a merchant on a printed matter, on the screen of an electronic device, or on another location, a user can log into the merchant's website, take part in an activity held by the merchant, become a member, etc.

Conventionally, if a user wants to obtain a specific service using a graphic code, the user must perform a scan using their terminal. However, this scanning operation inconveniences the user. For example, an advertising screen in an elevator lobby can display a QR code, but the time available to scan the QR code can be very short. Before the user has time to perform the scan, the elevator door can open and the user can only give up because the user is unable to obtain the relevant information or service.

### BRIEF DESCRIPTION OF THE DRAWINGS

Various embodiments of the invention are disclosed in the following detailed description and the accompanying drawings.

FIG. 1 is a flowchart of a first embodiment of a process for providing code scanning result information.

FIG. 2 is a flowchart of a second embodiment of a process for providing code scanning result information.

FIG. 3 is a flowchart of a third embodiment of a process for providing code scanning result information.

FIG. 4 is a flowchart of a fourth embodiment of a process for providing code scanning result information.

FIG. 5A is a diagram of a first embodiment of a device for providing code scanning result information.

FIG. 5B is a diagram of an embodiment of an information acquiring unit.

FIG. 6 is a diagram of a second embodiment of a device for providing code scanning result information.

FIG. 7 is a diagram of a third embodiment of a device for providing code scanning result information.

FIGS. 8A and 8B are diagrams of a fourth embodiment of a device for providing code scanning result information.

FIG. 9 is a diagram of an embodiment of a system for providing code scanning result information.

FIG. 10 is a diagram of an embodiment of a computer system for providing code scanning result information.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present application, code scanning result information is shared among multiple users to enable users to conveniently obtain information or services provided by service providers through graphic codes and other such information media. Since a large number of users exist on the Internet and the number of users performing code scans is also large, sharing code scanning result information among all users is not practical. Also, a specific individual user is not able to pay attention to all information or services. Therefore, a feasible implementation scheme, which is based on obtaining geographic locations of users and sharing code scanning results among users related by the obtained geographic location, is provided. For example, when a user is not able to timely scan a QR code displayed on a display screen in an elevator, scanning results of scanning actions previously performed near this geographic location of the elevator can be provided to the user, and these scanning results can include a scanning result corresponding to the QR code displayed on the elevator's display screen. Thus, even if the user is unable to personally scan the QR code, the user can still learn what is provided in the specific information or service corresponding to the QR code.

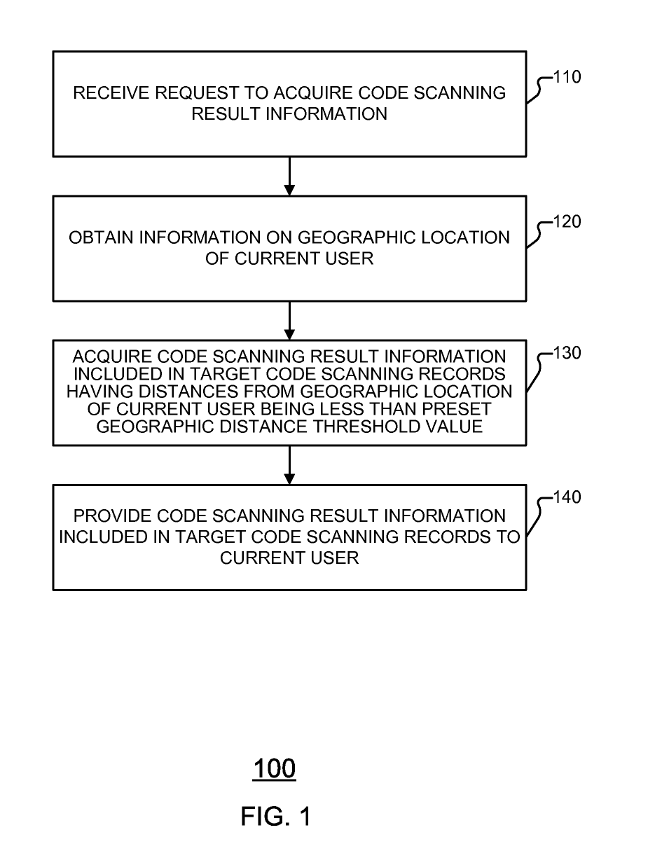

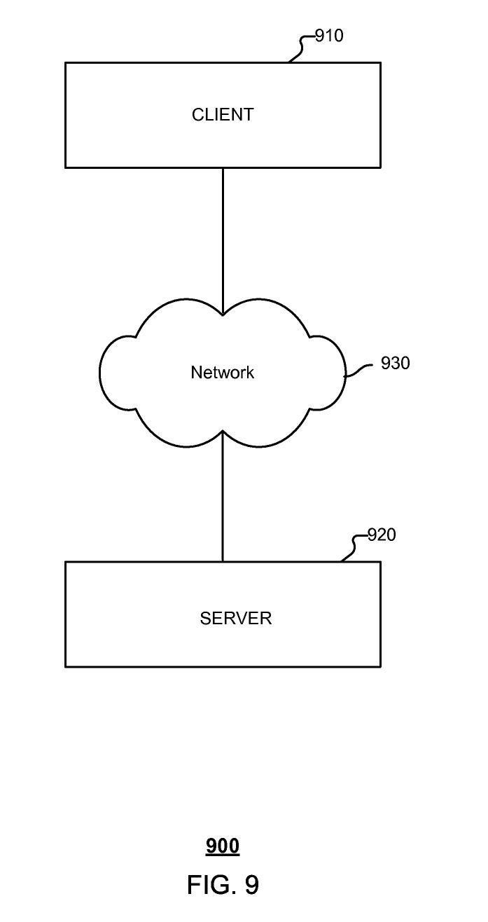

FIG. 1 is a flowchart of a first embodiment of a process for providing code scanning result information. In some embodiments, the process 100 is implemented by a client 910 of FIG. 9 and comprises:

In 110, the client receives a request to acquire code scanning result information.

In some embodiments, an operation entry point is provided on a client with scanning functions for a user. This operation entry point is used to acquire code scanning result information of other surrounding users. In some embodiments, the other surrounding users are located within a predefined distance from the user. For example, by default, a predefined distance of 100 meters can be configured. The user can adjust the distance settings on the client device. Instant messaging apps and price-comparison apps that are typically installed on terminals have a scanning function, or the terminals have a specialized scanning app. In some embodiments, the above operation entry point can be provided on user interfaces of these apps. Thus, when a user is to use a scanning function, the user can see the operation entry point on a user interface provided by such an application and then can trigger or send a request to acquire code scanning results of other users through the operation entry point.

In 120, the client obtains information on a geographic location of a current user.

In some embodiments, after receiving the request to acquire the code scanning results, the client first obtains information on the geographic location of the current user. In some embodiments, conventional approaches are employed to obtain the current geographic location of the user. For example, existing mobile terminals typically come with positioning systems (e.g., GPS systems). Therefore, information on the geographic location of the current user can be obtained from a positioning system of a mobile terminal using application interfaces provided by the positioning system. The user's geographic location information can also be determined based on information such as positioning of networks or base stations accessed by the user or Wi-Fi location.

Furthermore, acquiring information on the geographic location of the user in advance and then acquiring code scanning result information is possible, as is simultaneously performing both acquiring operations. In other words, the order of performance of operations 110 and 120 can be determined based on need (such as the operating environment).

In 130, the client acquires, based on code scanning records of other users, code scanning result information included in target code scanning records having distances from the geographic location of the current user that are less than a preset geographic distance threshold value. In some embodiments, the code scanning records further include geographic location information of corresponding users while performing code scanning actions.

In some embodiments, the code scanning results of users who previously performed code scanning actions near a certain geographic location to the requesting user who is currently located at that geographic location are to be provided. Therefore, code scanning result information corresponding to displayed (whether in paper or electronic form) graphic codes in various geographic locations can be collected in advance. For example, when a user uses a client with a scanning function to perform a scan, the code scanning result and the corresponding geographic location information can be uploaded to the server. Thus, the server collects information on the geographic locations where various users previously performed code scanning actions and the corresponding code scanning results, and thereby establishes database storing correspondences between code scanning result information and geographic location information.

When implemented, the code scanning result information can take many forms. For example, in a first implementation, code scanning result information simply corresponds to graphic codes that were scanned by users. In this first implementation, as stored in a server database, correspondences between the code scanning result information and the geographic location information are shown below in Table 1.

TABLE 1

| Sequential | Code scanning | Geographic location |
|---|---|---|
| number | result information | information |
| 1 | Graphic code 1 | Location 1 |
| 2 | Graphic code 2 | Location 2 |
| . . . | . . . | . . . |
| n | Graphic code n | Location n |

In a second implementation, a user can perform, for example, an image-taking operation directed at a graphic code while performing the code scanning action. The graphic code that the user is scanning is to thereby be captured. Subsequently, a scanning tool client is to store the graphic code together with a geographic location information of the current user in a database of the server.

In a third implementation, for example, the code scanning result information is analytic results obtained based on an analysis of the graphic code. In some embodiments, the analysis includes decoding the graphic code according to a known QR code or bar code decoding functions. Examples of the analytic results include link information (e.g., uniform resource locator (URL) information), web page information, product object information stored in the graphic code, or any combination thereof. In other words, in such a third implementation, correspondences between the code scanning result information stored in the server database and the geographic location information are shown below in Table 2:

TABLE 2

| Sequential | Code scanning | Geographic |
|---|---|---|
| number | result information | location information |
| 1 | Analytic result of graphic code 1 | Location 1 |
| 2 | Analytic result of graphic code 2 | Location 2 |
| . . . | . . . | . . . |
| n | Analytic result of graphic code n | Location n |

In the implementation, because the scanning tool client is to automatically analyze graphic codes when the scanning tool client scans the graphic codes and obtains analytic results, the scanning tool client can upload the graphic code analytic results and the current geographic location information to the server. Accordingly, the graphic code analytic results and the current geographic location information are stored in the database server, as shown in Table 2.

In some embodiments, the collection process is continually performed as users perform code scanning actions. In other words, the database established by the server is continually updated. In addition, in actual applications, different users can use different code scanning clients to perform code scanning. In some embodiments, the code scanning information is collected from multiple code scanning clients to increase information in the database.

After the server establishes a database that stores the correspondences between the code scanning result information and the geographic location information, the correspondences can be stored in the server database alone. Thus, when a client receives a request from the current user to acquire code scanning result information from previous code scanning operations performed by other surrounding users, the client can upload the geographic location information of the current user to the server. In this way, the server can look up, based on the stored code scanning records of other users, code scanning result information included in target code scanning records having distances from the current user's geographic location that are less than a preset geographic distance threshold value, and send the found code scanning result information back to the client. Therefore, the client can obtain the graphic codes that underwent code scanning by users at nearby geographic locations and the corresponding code scanning result information.

In some embodiments, different users may have scanned the same graphic code at different times in the same geographic location. In this case, the server, when updating the database, can test for such situations and upon finding similar situations, the server can merge those correspondences between code scanning result information and geographic location information that are the same. At the same time, the server can count the scanning frequency of the code scanning result information in the geographic location. Thus, the same correspondences of code scanning result information and geographic location information are to correspond to just one record in the database to reduce the size of the database. Moreover, scanning frequency records can also be used to determine the most popular code scanning result near a geographic location based on frequency so that the most popular code scanning result near the geographic location can receive priority when pushed to the user, etc.

In a fourth implementation, a “Frequency” field is added to a database table. After the “Frequency” field is added to the record format in Table 2, as an example, Table 3 is presented as follows:

TABLE 3

| | | Geographic | |
|---|---|---|---|
| Sequential | Code scanning result | location | |
| number | information | information | Frequency |
| 1 | Analytic result of graphic code | Location 1 | 4 |
| | 1 | | |
| 2 | Analytic result of graphic code | Location 2 | 8 |
| | 2 | | |
| . . . | . . . | . . . | |
| n | Analytic result of graphic code | Location n | 1 |
| | n | | |

In some embodiments, because the graphic codes themselves are stored as code scanning result information such as in the implementation described in Table 1, image comparison technology, such as pixel comparison, is used to determine whether the code scanning result information uploaded by different users is the same. For example, different images undergo pixel comparisons, and thus the client can determine whether two images are the same based on the pixel comparisons of the images. With respect to the implementation described in Table 2, because the code scanning result information stored in the database corresponds to analytic results derived from analyses of graphic codes (e.g., a URL string, a product name, a product identification, etc. that results from decoding the graphic codes), a direct comparison is to be performed of the analytic results of comparing two pieces of code scanning result information to determine whether the two pieces of code scanning result information are the same. For example, examples of comparisons include string comparisons to determine whether two links are the same, whether web addresses of two web pages are the same, etc. Regarding corresponding geographic location information, a determination is performed whether a distance between two geographic locations is less than a threshold distance value. In the event that the distance between the two geographic locations is less than the threshold distance value, the two geographic locations are considered the same geographic location. In other words, collected correspondences between two pieces of code scanning result information on the one hand and geographic locations on the other hand exist. In the event that the two pieces of code scanning information are the same and the distance between their corresponding geographic locations is less than the threshold distance value, the two correspondences can be merged into one record, and the frequency of the correspondence can be increased by one. As an aspect, in the event that one of piece of code scanning result information or geographic location information is different, the different piece is to be added as a different record to the database.

In some embodiments, to provide response information to the user upon receiving a request from the current user to acquire nearby code scanning result information, the server can push information to each client and update a client database periodically or non-periodically based on an update status of the server database. In the event that the client database is updated periodically, information that has been newly added or changed in the server database can be sent to the client at regular intervals. In the event that the client database is updated non-periodically, the server can push updated information to the client whenever the client user terminal is detected as being connected to the Internet via a wireless method such as Wi-Fi, 2G, 3G, or 4G, or via a wired method such as a cable. In this way, the user can avoid wasting bandwidth due to transmissions of large volumes of information by the terminal via a cellular data network.

In other words, where servers send information from databases to clients and perform information updates: after the client receives a request sent by the current user to acquire code scanning result information corresponding to graphic codes scanned nearby and acquires the geographic location information of the current user, the client can directly search for matching information in a locally stored database. Of course, since the client database is generally not as up to date as the server database, in the event that the client is unable to locate a matching result in the locally stored database, or in the event that the client locates very little data in the locally stored database, the client can upload the geographic location information of the current user to the server and obtain query results from the server database.

In 140, the client provides the code scanning result information included in the target code scanning records to the current user.

After the code scanning result information from graphic codes scanned near the current geographic location is acquired, the code scanning result information can be provided to the user. For example, the code scanning result information can be displayed in the form of a list on a client user interface, or the code scanning result information can be played to the user in an audio form in the event that the code scanning result information corresponds to analytic results from graphic codes, etc.

In some embodiments, in the event that the code scanning result information in the database records corresponds to the graphic codes themselves, the equivalent of images of the graphic codes scanned by other users near the current location can be provided to the current user. In this case, in the event that the client has its own function that directly analyzes graphic code images, the client can directly analyze the graphic codes and then display the acquired corresponding analytic results to the current user. In some embodiments, in the event that the client itself cannot analyze the graphic codes, the user can use a scanning tool including a decoding function installed on another terminal to scan and analyze the graphic code, and thus obtain analytic results from the other terminal. In the event that the code scanning result information of the database records already includes analytic results from the analysis of the graphic codes, the analytic results can be directly displayed or played on the current terminal without further requiring a code scanning analysis operation. In other words, when a user is to acquire code scanning information while in a particular geographic location, the client can first acquire information on the current geographic location of the current user and then provide, to the current user, the analytic results corresponding to the graphic codes scanned previously by other users near this geographic location. For example, the information can correspond to product names and prices associated with a barcode or merchant event information corresponding to a QR code or other information such as a link address. In other words, without actually scanning the specific QR code or barcode, the current user can still view the analytic result corresponding to the QR code or barcode, as if the user had personally scanned the QR code or barcode. Therefore, the O2O service model can be effective, and users can efficiently obtain relevant information or services.

For example, a user in an elevator sees an advertisement displayed on a screen. The advertisement, which is about to switch to another advertisement, includes a QR code. At this time, the user does not need to immediately scan the QR code because even if the user has just reached their destination floor and does not have time to scan the QR code, the user can, after leaving the elevator, locate, on a user interface of a code scanning application, an operating entry point for viewing code scanning result information from scans of nearby users. After entering the operating entry point, the user can view graphic codes that were previously scanned by other users near the present location and code scanning result information corresponding to the previously scanned graphic codes. The previously scanned graphic codes can include the graphic code in the advertisement that the user just saw in the elevator.

In an example of another application scenario, assume that a user is shopping in a supermarket and would like to compare prices of products in the supermarket with prices of corresponding products in e-commerce websites of other merchants. If the user is to scan the products one at a time, that scanning process can utilize a great deal of time and would be inconvenient. In this case, the user can locate, on the user interface of the code scanning application, the operating entry point to view code scanning result information from scans of nearby users. After locating the operating entry point, the user can view which products were previously scanned by other users in this supermarket and compare, for example, prices or other information of the products obtained from links of the product producers' websites. This technique corresponds to collecting code scanning results from other users and then providing the code scanning results to a user. This technique can increase the rate whereby the user acquires code scanning results.

In an example of yet another application scenario, a merchant can display QR codes near their own stores. By using a QR code, a user can participate in a promotional event of the merchant or become a member of the merchant's loyalty program. As an aspect, if the user knows that the merchant is holding the event and is not familiar with the specific location of the merchant's store or has arrived at a mall where the merchant is located but does not know where the promotional event is being held, the user can locate, on the user interface of the code scanning application, the operating entry point for viewing code scanning result information from scans of nearby users. After entering this operating entry point, the user can view products that were previously scanned by other users and the code scanning result information corresponding to the previously scanned products. Thus, the current user can obtain information on promotional events of many merchants in the mall. Also, if the merchant has included the merchant's own address (e.g., the floor number and store number of the merchant's store in the mall) into the code scanning results, the current user can locate the merchant's store based on the merchant's own address. The current user can participate in the promotional event or become a member of the merchant's loyalty program by personally scanning the graphic code provided by the merchant.

In some embodiments, a navigating operation is also included. For example, a route is determined based on the acquired geographic location information of the current user and address information for at least one piece of code scanning result information, e.g., a merchant's address.

In some embodiments, this route refers to a walking route from the geographic location of the current user to the address corresponding to at least one piece of code scanning result information. In some embodiments, the code scanning result information includes address information. To determine the route, the user's geographic location corresponds to a departure point, the address information of the code scanning results information corresponds to a destination, and map data is determined based on the departure point and the destination. The map data can be obtained based on known navigation technology.

In some embodiments, this navigation operation is performed in operation 140. In other words, when the code scanning result information included in the target code scanning records is provided to the current user, the route from the geographic location information of the current user to the address corresponding to at least one piece of code scanning result information is provided together with the above code scanning result information to the current user.

In some embodiments, the navigation operation is performed after operation 140. After operation 140, the route from the geographic location information of the current user to the address corresponding to at least one piece of code scanning information selected by the user can be determined based on at least one piece of code scanning result information selected by the user, and the determined route can be provided to the current user.

In some embodiments, a graphic code displayed (in paper or electronic form) in the same geographic location and the corresponding code scanning result information can continually change. In some embodiments, in the event that the analytic result corresponding to the graphic code is a promotional event, typically, the event has an expiration date. For example, a QR code displayed on an advertising screen is to change as one advertisement is substituted for another advertisement. In the event that the code scanning result information of a graphic code scanned long ago by other users is provided to a current user, the graphic code may already be invalid or out of date. Therefore, when a database stores correspondences, the database can add another field: “Scan time.” At the same time, the database can also set a time limit for keeping each correspondence. For example, the database keeps collected data for the most recent period (e.g., 48 hours). In another example, the database adds an “Expiration date” field to the database table, and the database is capable of learning of activities corresponding to graphic codes or the expiration date of information (e.g., identifying text content in graphic code analytic results and acquiring valid information from the text content is possible). The relevant information can be entered into the “Expiration date” field. During maintenance of various records in the database, deleting corresponding records if a record has already expired is possible. In the event that no data in a record's “Expiration date” field exists, a determination can be made as to whether a record is to be deleted based on a preset retention period. This preset retention period can prevent the database from becoming very large and prevent invalid information from being provided to users.

In an example, code scanning time point information is collected at the same time that code scanning result information and geographic location information are collected. For example, after the “Scan time information” and “Expiration date” fields have been added in an implementation of Table 3, the database table corresponds to Table 4 below:

TABLE 4

| | Code scanning | Geographic | | Scan time | Expi- |
|---|---|---|---|---|---|
| Sequential | result | location | Fre- | infor- | ration |
| number | information | information | quency | mation | date |
| 1 | Analytic result | Location 1 | 4 | 2014/2/12 | Feb. 14, |
| | of graphic code | | | 13:10 | 2014 |
| | 1 | | | | |
| 2 | Analytic result | Location 2 | 8 | 2014/2/12 | |
| | of graphic code | | | 16:30 | |
| | 2 | | | | |
| 3 | Analytic result | Location 3 | 2 | 2014/2/13 | |
| | of graphic code | | | 8:30 | |
| | 3 | | | | |
| 4 | Analytic result | Location 4 | 3 | 2014/2/13 | Feb. 16, |
| | of graphic code | | | 15:20 | 2014 |
| | 4 | | | | |
| 5 | . . . | . . . | . . . | . . . | . . . |
| n | Analytic result | Location n | 1 | 2014/2/13 | |
| | of graphic code | | | 18:50 | |
| | n | | | | |

Thus, always stored in the database is code scanning result information from scanning time points that are no more distant from the current time point than defined by a certain time threshold value. Also, the code scanning result information that still has not expired is stored in the database. Therefore, the code scanning result information is equivalent to the following: target code scanning records having distances from the geographic location of the current user that are less than a preset geographic location distance value, the target code scanning records are acquired from code scanning records having distances from the current time point that are less than a preset time distance threshold value and from code scanning result information that still has not expired, and the code scanning result information corresponding to the target code scanning records is provided to the user. Thus, obtaining the code scanning result information corresponding to graphic codes scanned by other users near the location within the latest interval of time and providing the code scanning result information to the current user are possible. These obtaining and providing operations can help the current user acquire the most valid information.

Furthermore, in an actual application, when collecting the code scanning result information of other users and corresponding graphic location information, collecting user information, such as user name, is also possible. Thus, when the code scanning result information is provided to the current user, the user information of the scanning parties can also be provided to the current user so that the current user can learn which users previously performed nearby code scanning operations. In some embodiments, because the user name and other user information can include the users' private information, users are asked in advance whether their user information is to be made public. User information is to be provided to the current user in the event that the user consents to making their user information publicly available.

In the event that the user information is recorded, a “User information” field can also be added to the database table. In the event that different users scan the same graphic code at the same location and their records are merged, all the users' information can be stored in the user information field. For example, in the event that the information record format of Table 4 is used, the database table includes the addition of the “User information” field as shown in Table 5:

TABLE 5

| | Code scanning | Geographic | | | | |
|---|---|---|---|---|---|---|
| Sequential | result | location | | User | Scan time | Expiration |
| number | information | information | Frequency | information | information | date |
| 1 | Analytic result | Location 1 | 4 | User 1, | 2014 Feb. 12 | Feb. 14, 2014 |
| | of graphic code | | | User 2, | 13:10 | |
| | 1 | | | User 3, | | |
| | | | | User 4 | | |
| 2 | Analytic result | Location 2 | 8 | User 5, | 2014 Feb. 12 | |
| | of graphic code | | | User 6, | 16:30 | |
| | 2 | | | . . . User 12 | | |
| . . . | . . . | . . . | . . . | | . . . | . . . |
| n | Analytic result | Location n | 1 | User m | 2014 Feb. 13 | |
| | of graphic code | | | | 18:50 | |
| | n | | | | | |

Furthermore, in the event that a very large number of target code scanning records matched with a geographic location is located, an excessive number of target code scanning records provided to the user increases the difficulty for the user to acquire the desired information. Therefore, in some embodiments, to facilitate user viewing, the current user is provided with only code scanning result information corresponding to records having frequencies higher than a threshold value. In some embodiments, the user is to obtain the code scanning result information corresponding to the most popular graphic codes at the current geographic location. In some embodiments, all of the target code scanning records are categorized and presented to the user. For example, the target code scanning records are divided into multiple categories such as by group or by theme. As an example, the categories include electronics, cuisine, apparel, etc. In addition, the initial mode may present only category titles corresponding to each category. When an operation is performed on a category, all the target code scanning records included under that category could be opened and displayed. The category information corresponding to each code scanning record can be set up in advance by the server. For example, in a large mall, nearby code scanning content includes many different types of graphic codes (e.g., product barcodes, merchant event QR codes, etc.). The system categorizes and presents to the user the content by identifying code content type corresponding to the graphic codes. For example, the classification could be performed based on the content type in a code content bank. For example, when code scanning records are stored for all users, an “Information type” field can be added to the database table. This database table including the “Information type” field is the equivalent of categorizing and storing product information, QR code information, etc. Thus, when the information is later displayed to users, the information can be directly displayed in a categorized form, for example, as shown in Table 6:

TABLE 6

| | Code scanning | Geographic | | | | | |
|---|---|---|---|---|---|---|---|
| Sequential | result | location | | User | Scan time | Expiration | Information |
| number | information | information | Frequency | information | information | date | category |
| 1 | Analytic | Location 1 | 4 | User 1, | 2014 Feb. 12 | Feb. 14, 2014 | Product |
| | result of | | | User 2 | 13:10 | | information |
| | graphic code | | | User 3, | | | |
| | 1 | | | User 4 | | | |
| 2 | Analytic | Location 2 | 8 | User 5, | 2014 Feb. 12 | | Product |
| | result of | | | User 6 | 16:30 | | information |
| | graphic code | | | . . . User 12 | | | |
| | 2 | | | | | | |
| . . . | . . . | . . . | . . . | | . . . | . . . | |
| n | Analytic | Location n | 1 | User m | 2014 Feb. 13 | | QR code |
| | result of | | | | 18:50 | | information |
| | graphic code | | | | | | |
| | n | | | | | | |

In addition, in some embodiments, different users are divided into many categories based on shared interests and hobbies, such as electronics, cuisine, apparel, etc. In the event that code scanning result information can be shared among different users within the same category, information utilization rates can be increased to achieve a higher user satisfaction. Therefore, in some embodiments, after the code scanning result information for the graphic codes scanned nearby by other users is acquired, determining scanning parties having the same shared interests and hobbies as the current user is possible where the scanning parties correspond to separate target code scanning records. Subsequently, the code scanning result information included in the target code scanning records corresponding to the scanning parties having the same shared interests and hobbies as the current user is to be provided to the current user.

In some embodiments, to facilitate querying, a “User category” field is added to the database table. The user category of the scanning party users is to be recorded when the correspondences are recorded. In the event that different users scan the same graphic code at the same location and their records are merged, all the users' information is to be recorded in the “User category” field. Among different users corresponding to the same record, some users can belong to the same category. Therefore, the information is to be recorded only once. Using the information record format in Table 6 as an example, the first four users scanned graphic code 1. Of these first four users, user 1 and user 3 belong to category 1, and user 2 and user 4 belong to category 2. Therefore, in the “User category” field, recording just “Category 1” and “Category 2” is sufficient. The remaining records can also be processed similarly. For example, the database table after the user category field has been added is shown in Table 7:

TABLE 7

| | Code | | | | | | | |
|---|---|---|---|---|---|---|---|---|
| | scanning | Geographic | | | | | | |
| Sequential | result | location | | User | User | Scan time | Expiration | Information |
| number | information | information | Frequency | information | category | information | date | category |
| 1 | Analytic | Location 1 | 2 | User 1, user | Category | 2014 Feb. 12 | Feb. 14, 2014 | Product |
| | result of | | | 2, user 3, | 1 | 13:10 | | information |
| | graphic | | | user 4 | Category | | | |
| | code 1 | | | | 2 | | | |
| 2 | Analytic | Location 2 | 1 | User 5, user | Category | 2014 Feb. 12 | | Product |
| | result of | | | 6. . . user 12 | 2 | 16:30 | | information |
| | graphic | | | | Category | | | |
| | code 2 | | | | 3 | | | |
| . . . | . . . | . . . | . . . | . . . | . . . | . . . | . . . | |
| n | Analytic | Location n | 1 | User m | Category | 2014 Feb. 13 | | QR code |
| | result of | | | | x | 18:50 | | information |
| | graphic | | | | | | | |
| | code n | | | | | | | |

Many criteria for dividing up categories of same-category users can exist. For example, multiple categories are distinguished based on the interests and hobbies of users, etc. In some embodiments, user categories are divided up in advance. For example, users are categorized based on information included in user information entered by each user on a server. For example, a category can include male users and female users. In another example, the categories can be delineated based on other dimensions or granularities. For example, the apparel category can be further divided into children's apparel, women's apparel, men's apparel, etc. In yet another example, users are assigned to corresponding categories based on operating object information from user online shopping or browsing actions. Thus, to provide the current user with the code scanning result information of nearby other users, only the code scanning result information previously scanned by users who were near the current location and who are in the category that the current user belongs to are to be searched and displayed. After receiving a current user query request to read the user information and/or preference data (which can be computed from existing preference algorithm dimensions) of users, figuring out the status, age, personal preference, and other features of the user is possible. Subsequently, locating users who perform scans near the current location and are similar to the user in terms of status, age, personal preference, etc. is possible, as well as displaying the code scanning result information scanned by those users to the current user.

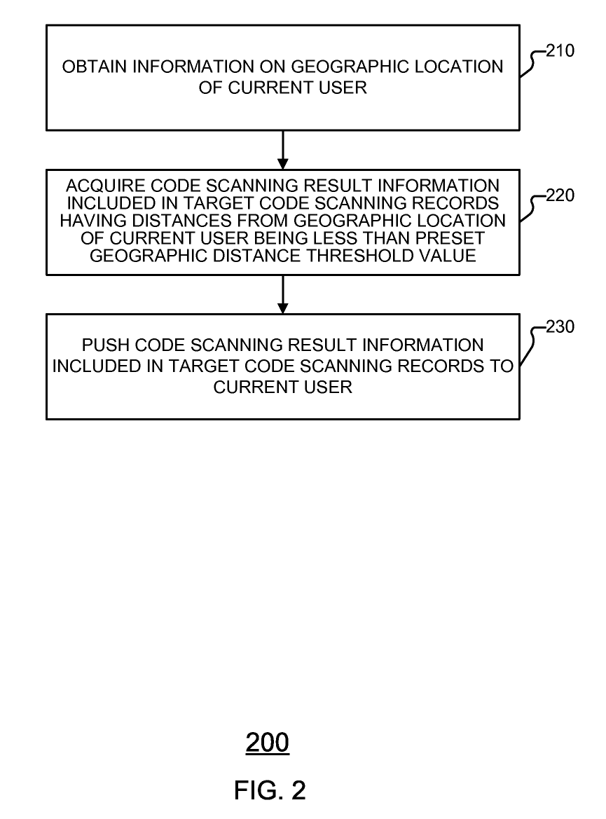

The above process 100 of FIG. 1 introduced how code scanning result information is provided when a user issues a request to acquire code scanning results. In the below process 200 of FIG. 2, the code scanning tool can proactively push, to the user, information on graphic codes that were previously scanned near the user's location based on real-time geographic location information of the user.

FIG. 2 is a flowchart of a second embodiment of a process for providing code scanning result information. In some embodiments, the process 200 is implemented by a client 910 of FIG. 9 and comprises:

In 210, the client obtains information on a geographic location of a current user.

In 220, the client acquires code scanning result information included in target code scanning records having distances from the geographic location of the current user that are less than a preset geographic distance threshold value. The code scanning result information is acquired based on the code scanning records of other users and all the code scanning records include information on the geographic location of corresponding users while performing code scanning actions.

In 230, the client pushes the code scanning result information included in the target code scanning records to the current user. For example, alert messages or the like can be displayed by the client.

Operations 120 to 140 of process 100 of FIG. 1 correspond to operations 210 to 230 of FIG. 2. Therefore, the description of operations 120 to 140 of process 100 of FIG. 1 can be referenced and will not be discussed further for conciseness.

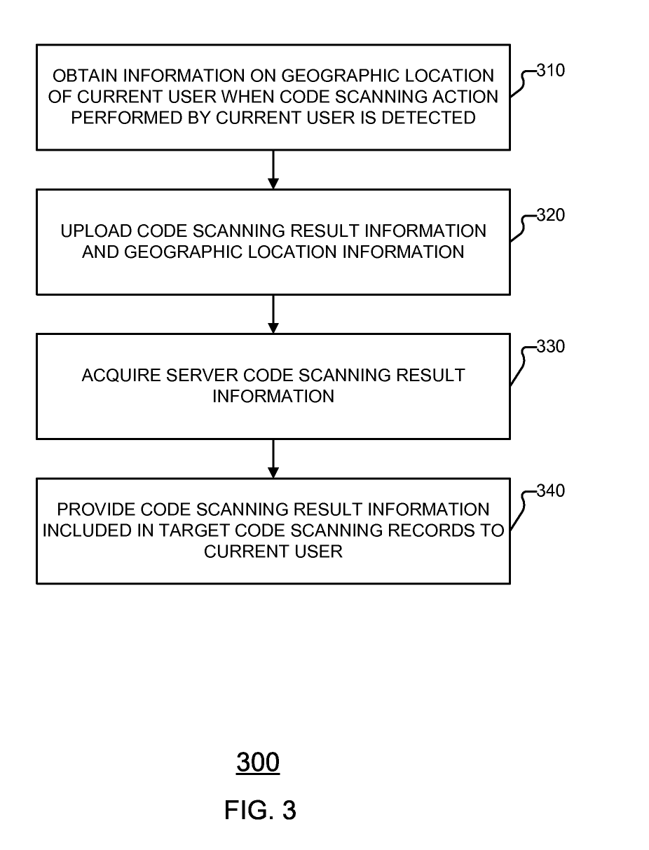

FIG. 3 is a flowchart of a third embodiment of a process for providing code scanning result information. In some embodiments, the process 300 is implemented by a client 910 of FIG. 9 and comprises:

In 310, the client obtains information on a geographic location of a current user when a code scanning action performed by the current user is detected.

In 320, the client uploads code scanning result information corresponding to the code scanning action, and the corresponding geographic location information to a server. In some embodiments, the server stores the code scanning result information and the corresponding geographic location information in code scanning records.

In 330, in the event that code scanning result information is to be acquired, the client requests and acquires, based on the geographic location information of the current user, the server code scanning result information included in target code scanning records having distances from the current user that are less than a preset geographic distance threshold value.

In 340, the client provides the code scanning result information included in the target code scanning records to the current user.

In some embodiments, uploading user information corresponding to code scanning actions to the server is possible, so that when the server sends code scanning result information included in target code scanning records back to the inquirer client, the server also sends back the corresponding user information.

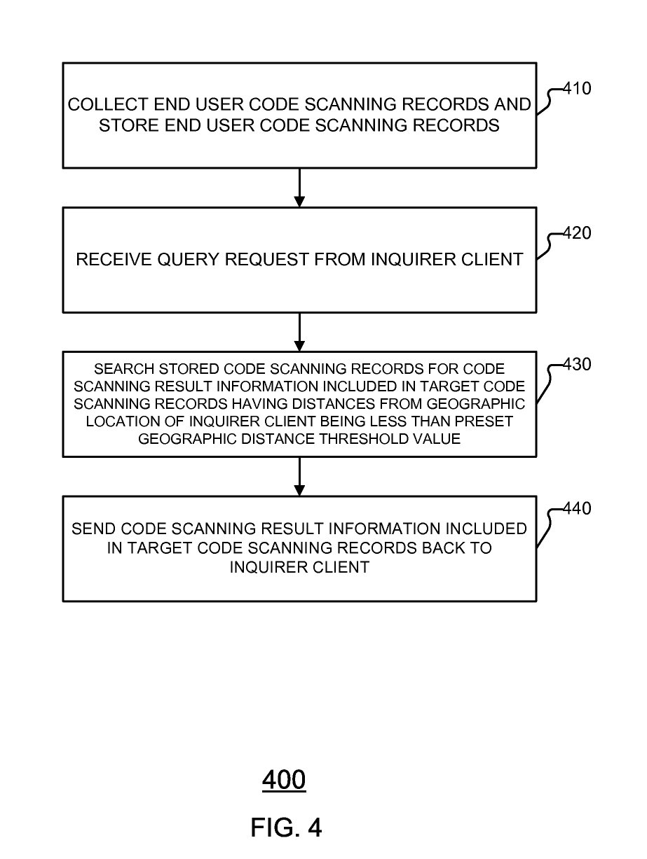

FIG. 4 is a flowchart of a fourth embodiment of a process for providing code scanning result information. In some embodiments, the process 400 is implemented by a server 920 of FIG. 9 and comprises:

In 410, the server collects end user code scanning records and stores the end user code scanning records. In some embodiments, the code scanning records include correspondences between code scanning result information and geographic location information.

In 420, the server receives a query request from an inquirer client. In some embodiments, the query request includes geographic location information of the inquirer client.

In 430, the server searches the stored code scanning records for code scanning result information included in target code scanning records having distances from the geographic location of the inquirer client that are less than a preset geographic distance threshold value, and acquires the code scanning result information from the stored code scanning records.

In 440, the server sends the code scanning result information included in the target code scanning records back to the inquirer client to provide the code scanning result information included in the target code scanning records to the user.

Process 300 of FIG. 3 and process 400 of FIG. 4 differ from process 100 of FIG. 1 in the point of view from which they are described. All of the relevant implementations have been described in the description of process 100 of FIG. 1 and will not be repeated for conciseness.

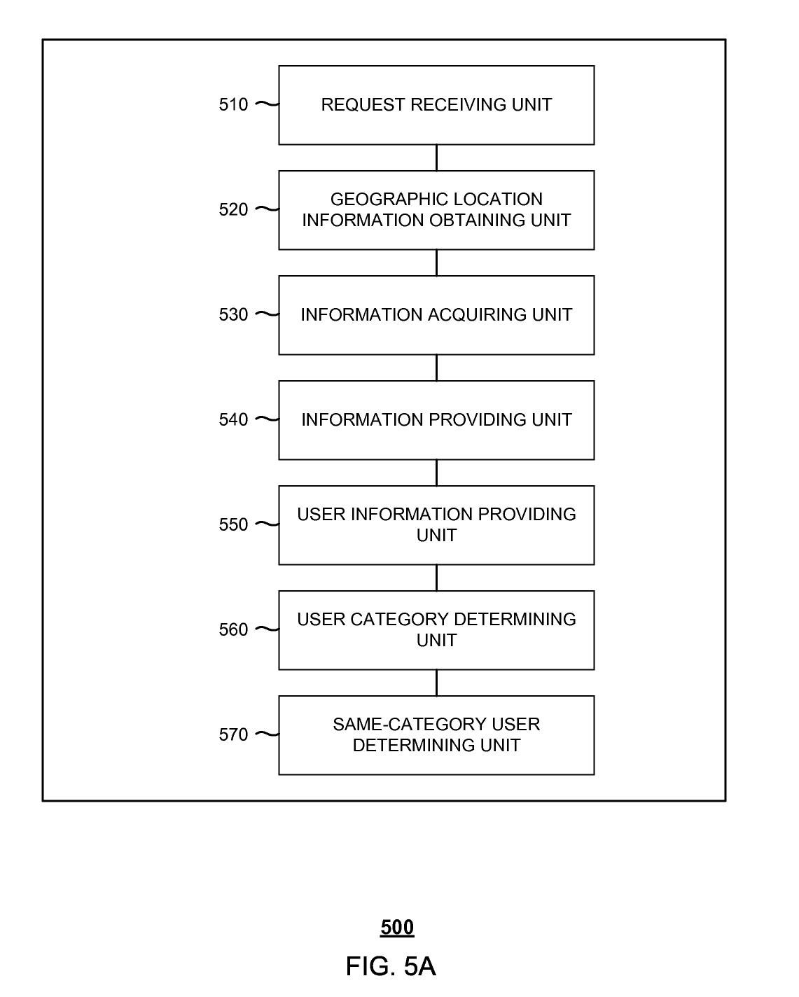

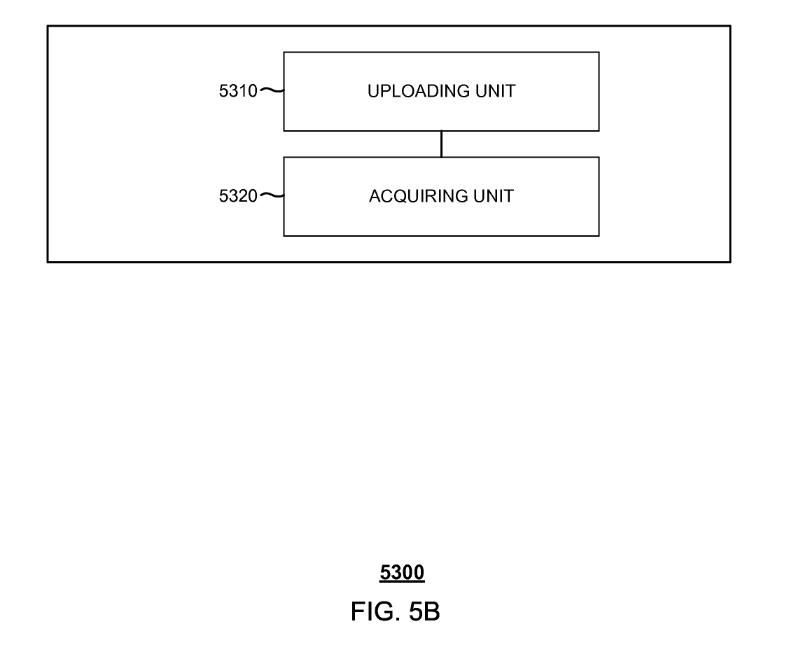

Multiple code scanning records are stored in advance in a database. The code scanning records include code scanning result information and corresponding geographic location information at the time that code scans were performed. FIG. 5A is a diagram of a first embodiment of a device for providing code scanning result information. In some embodiments, the device 500 is configured to implement the process 100 of FIG. 1 and comprises: a request receiving unit 510, a geographic location information obtaining unit 520, an information acquiring unit 530, and an information providing unit 540.

In some embodiments, the request receiving unit 510 receives a request to acquire code scanning result information.

In some embodiments, the geographic location information obtaining unit 520 obtains information on a geographic location of the current user.

In some embodiments, the information acquiring unit 530, based on all the code scanning records in the database, acquires code scanning result information included in target code scanning records having distances from the geographic location of the current user that are less than a preset geographic distance threshold value.

In some embodiments, the information providing unit 540 provides the code scanning result information included in the target code scanning records to the current user.

In some embodiments, the code scanning records of other users are stored on the server.

FIG. 5B is a diagram of an embodiment of an information acquiring unit. In some embodiments, the information acquiring unit 5300 corresponds to the information acquiring unit 530 of FIG. 5A and comprises an uploading unit 5310 and an acquiring unit 5320.

In some embodiments, the uploading unit 5310 uploads geographic location information on the current user to the server so that the server can, based on the stored code scanning records of other users, search code scanning result information included in target code scanning records having distances from the geographic location of the current user that are less than a preset geographic distance threshold value and send the search code scanning result information back.

In some embodiments, the acquiring unit 5320 acquires, based on the information sent back by the server, the code scanning result information included in the target code scanning records.

In some embodiments, the code scanning result information included in the code scanning records of the database is graphic code information itself or analytic results from an analysis performed on graphic codes.

In some embodiments, time point information corresponding to times when corresponding users perform code scanning actions is stored in the code scanning records.

Referring back to FIG. 5A, at this point, the information acquiring unit 530 performs the following: from among code scanning records having distances from the current time point that are less than a preset time distance threshold value, acquiring code scanning result information included in target code scanning records having distances from the geographic location of the current user that are less than a preset geographic distance threshold value.

In some embodiments, the code scanning records further include user information corresponding to code scanning actions, and the device further comprises a user information providing unit 550.

In some embodiments, the user information providing unit 550 provides user information corresponding to target code scanning records to the current user.

In addition, in some embodiments, the code scanning records of the database further comprise occurrence frequency information for all code scanning records. In this case, the information providing unit 540 can provide the current user with code scanning result information included in target code scanning records having relatively high occurrence frequencies.

In addition, in some embodiments, the code scanning records of the database further comprise corresponding code scanning result category information.

In some embodiments, the information providing unit 540 provides the code scanning result information included in the target code scanning records based on the category information to the current user.

In some embodiments, the device further comprises a user category determining unit 560 and a same-category user determining unit 570.

In some embodiments, the user category determining unit 560 determines a category to which the current user belongs.

In some embodiments, the same-category user determining unit 570 determines which of the scanning parties corresponding to the various target code scanning records belong to the same category of user as the current user.

In some embodiments, the information providing unit 540 provides, to the current user, code scanning result information included in the target code scanning records corresponding to the scanning parties that belong to the same category of user as the current user.

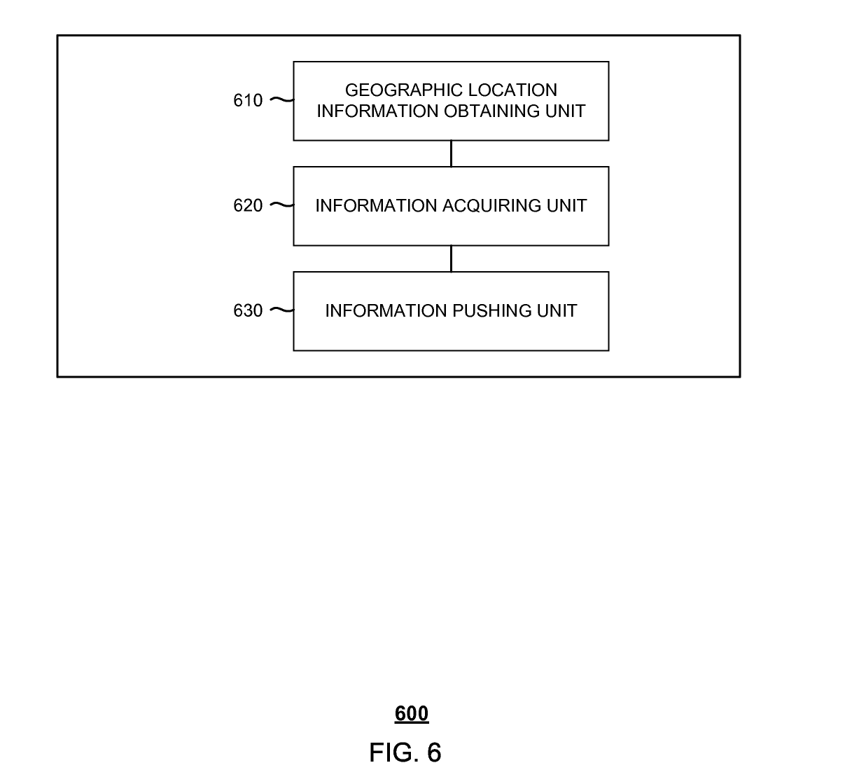

FIG. 6 is a diagram of a second embodiment of a device for providing code scanning result information. In some embodiments, the device 600 is configured to implement the process 200 of FIG. 2. In some embodiments, the device 600, like device 500 of FIG. 5A, pre-stores multiple code scanning records in a database, and the code scanning records include code scanning result information and corresponding geographic location information on users while the users are performing code scanning actions. The difference between devices 500 and 600 is that in device 600, no request is to be issued to provide the user with code scanning result information of other users. Instead, the geographic location information of the user serves as a basis for proactively pushing code scanning result information of other users to the user. In some embodiments, the device 600 comprises a geographic location information obtaining unit 610, an information acquiring unit 620, and an information pushing unit 630.

In some embodiments, the geographic location information obtaining unit 610 obtains information on the geographic location of the current user.

In some embodiments, the information acquiring unit 620, based on all the code scanning records in the database, acquires code scanning result information included in target code scanning records having distances from the geographic location of the current user that are less than a preset geographic distance threshold value.

In some embodiments, the information pushing unit 630 pushes the code scanning result information included in the target code scanning records to the current user. In some embodiments, the code scanning result information is pushed to the user by displaying the information as a message on the client device.

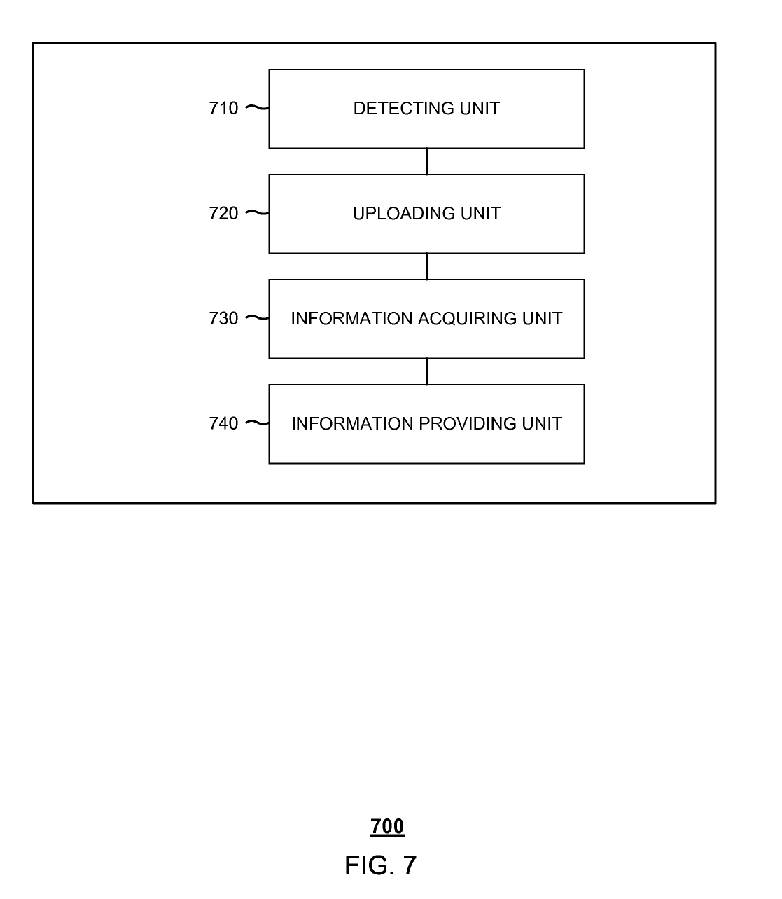

FIG. 7 is a diagram of a third embodiment of a device for providing code scanning result information. In some embodiments, the device 700 is configured to implement the process 300 of FIG. 3 and comprises: a detecting unit 710, an uploading unit 720, an information acquiring unit 730, and an information providing unit 740.

In some embodiments, the detecting unit 710 obtains a geographic location information of a current user when a scan action performed by the current user is detected.

In some embodiments, the uploading unit 720 uploads code scanning result information corresponding to the code scanning action and the corresponding geographic location information to a server so that the server can store the code scanning result information and a correspondence with the geographic location information in code scanning records.

In some embodiments, when the code scanning result information is to be acquired, the information acquiring unit 730, based on information on the geographic location of the current user, requests and acquires from the server code scanning result information included in target code scanning records having distances from the current user that are less than a preset geographic distance threshold value.

In some embodiments, the information providing unit 740 provides the code scanning result information included in the target code scanning records to the current user.

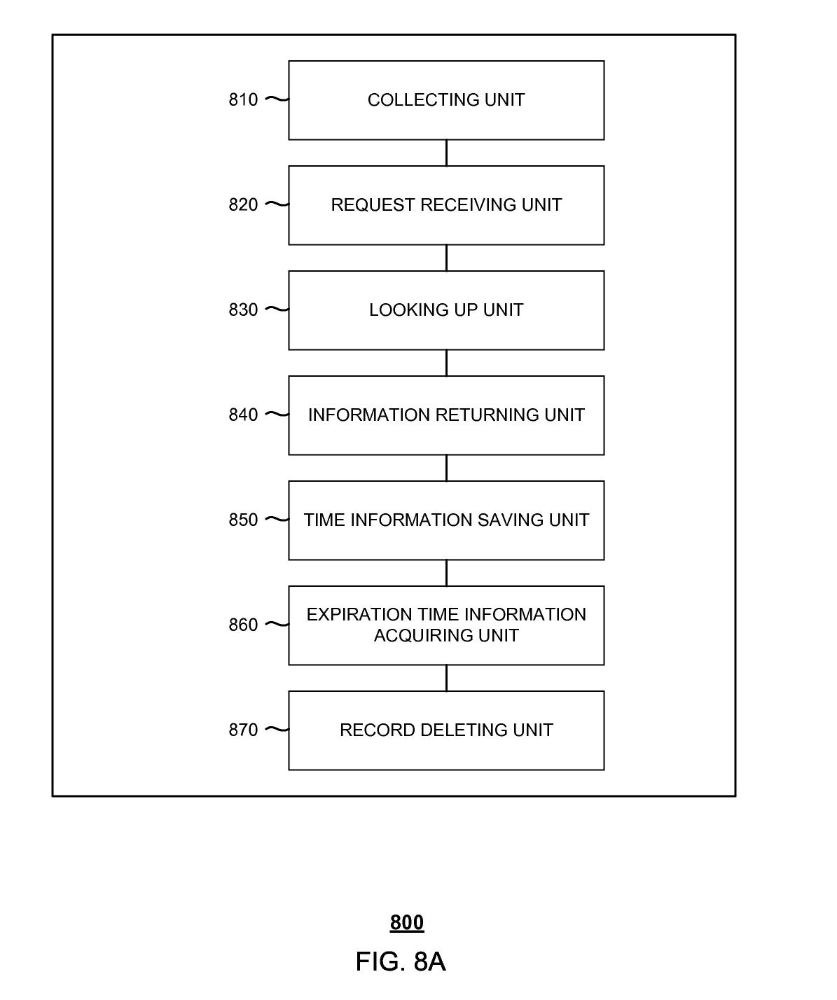

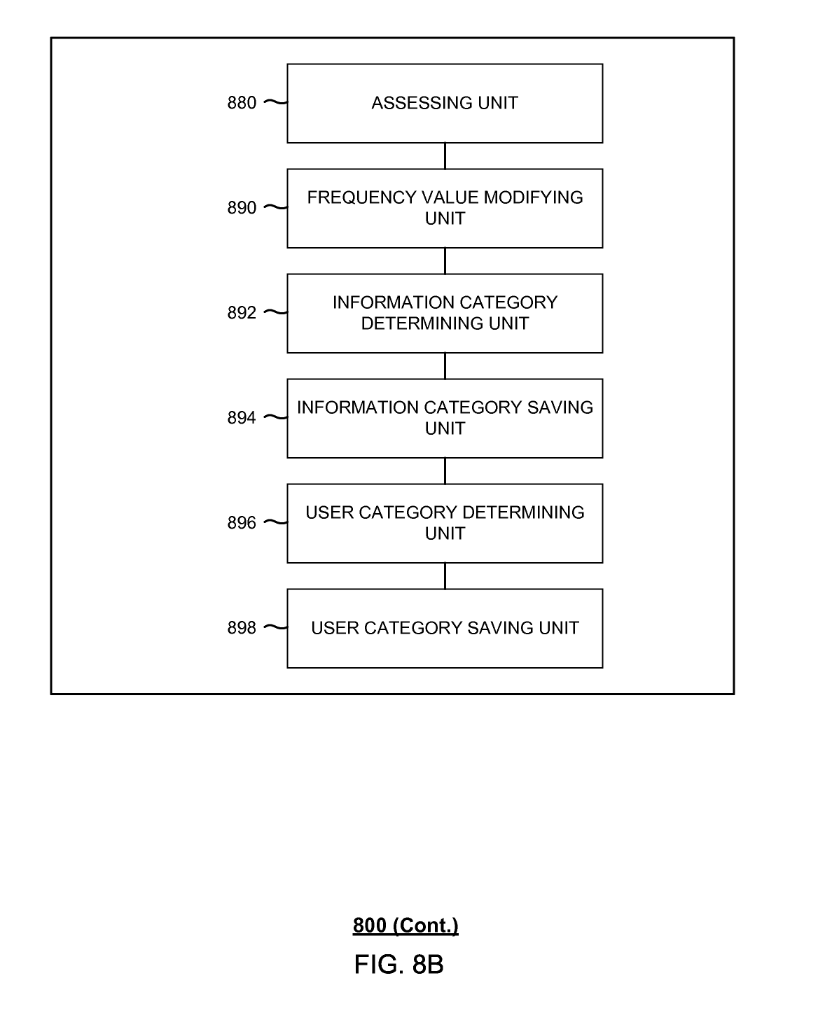

FIGS. 8A and 8B are diagrams of a fourth embodiment of a device for providing code scanning result information. In some embodiments, the device 800 is configured to implement the process 400 of FIG. 4 and comprises: a collecting unit 810, a request receiving unit 820, a looking up unit 830, and an information returning unit 840.

In some embodiments, the collecting unit 810 collects end user code scanning records and stores the end user code scanning records in a database. In some embodiments, the code scanning records store correspondences between code scanning result information and information on the geographic locations of users when performing code scanning actions.

In some embodiments, the request receiving unit 820 receives a query request sent from an inquirer client. In some embodiments, the query request includes geographic location information of the inquirer client.

In some embodiments, the looking up unit 830, based on stored code scanning records, acquires code scanning result information included in target code scanning records having distances from the geographic location of the inquirer client that are less than a preset geographic distance threshold value.

In some embodiments, the information returning unit 840 sends the code scanning result information included in the target code scanning records back to the inquirer client so that the inquirer client can provide the code scanning result information included in the target code scanning records to the user.

In some embodiments, the device 800 further comprises: a time information saving unit 850.

In some embodiments, the time information saving unit 850 stores time point information for times when corresponding users performed code scanning actions in the code scanning records.

In some embodiments, to ensure the validity of information stored in the database, the device further includes: an expiration time information acquiring unit 860 and a record deleting unit 870.

In some embodiments, the expiration time information acquiring unit 860 acquires expiration time information of each code scanning record.

In some embodiments, the record deleting unit 870 deletes a code scanning record from the database in the event that a code scanning record reaches its expiration time.

In some embodiments, in order to provide the user with code scanning information on a graphic code that is currently most popular, frequency information is also included in the code scanning records of the database. Accordingly, in some embodiments, the device further comprises: an assessing unit 880 and a frequency value modifying unit 890.

In some embodiments, the assessing unit 880, when a new correspondence between code scanning result information and geographic location information is received, determines whether the existing code scanning records in the database already include this correspondence.

In some embodiments, the frequency value modifying unit 890, in the event that the assessing unit 880 determines that the existing code scanning records in the database already include this correspondence, merges the correspondence including the existing code scanning record and adds one to a value of a frequency field in the existing code scanning record.

In some embodiments, in order to provide category-based code scanning information to the user, the device further comprises: an information category determining unit 892 and an information category saving unit 894.

In some embodiments, the information category determining unit 892 determines category information of the code scanning result information included in the code scanning records.

In some embodiments, the information category saving unit 894 stores the category information in the code scanning records.

In some embodiments, to push code scanning result information to users having the same interests, the device further comprises: a user category determining unit 896 and a user category saving unit 898.

In some embodiments, the user category determining unit 896 determines user category information of scanning parties included in the code scanning records.

In some embodiments, the user category saving unit 898 stores the user category information in the code scanning records.

When a user in a certain location is to acquire code scanning information, the client can first acquire information on the current geographic location of the current user and then the code scanning result information corresponding to graphic codes scanned previously by other users near this location. Examples of the code scanning result information include product names, prices and other such information corresponding to barcodes or merchant activity information corresponding to QR codes. Also, other examples of the code scanning result information include link address or other information. In other words, without having to actually scan the specific QR code or barcode, the current user still can view the code scanning result information corresponding to the QR code or barcode, as if the user had actually scanned the QR code or barcode. Therefore, the O2O service model increases the capability to obtain relevant information or services.

FIG. 9 is a diagram of an embodiment of a system for providing code scanning result information. In some embodiments, the system 900 includes a server 920 connected to a client 910 via a network 930.

In some embodiments, the client 910 receives a request to acquire code scanning result information, obtains information on the geographic location of a current user, sends the geographic location information to the server 920, acquires, from the server 920, code scanning result information included in target code scanning records having distances from the geographic location of the current user that are less than a preset geographic distance threshold value based on code scanning records of other users, and provides the code scanning result information included in the target code scanning records to the current user.

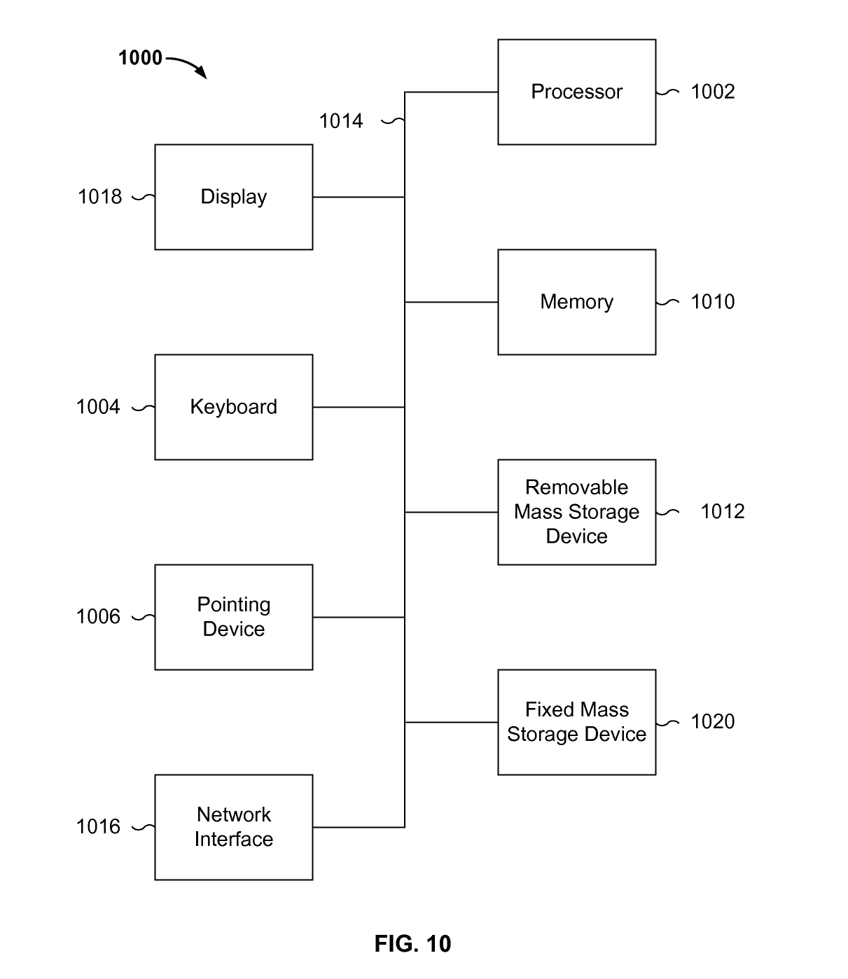

FIG. 10 is a functional diagram illustrating an embodiment of a programmed computer system for providing code scanning result information. As will be apparent, other computer system architectures and configurations can be used to provide code scanning result information. Computer system 1000, which includes various subsystems as described below, includes at least one microprocessor subsystem (also referred to as a processor or a central processing unit (CPU)) 1002. For example, processor 1002 can be implemented by a single-chip processor or by multiple processors. In some embodiments, processor 1002 is a general purpose digital processor that controls the operation of the computer system 1000. Using instructions retrieved from memory 1010, the processor 1002 controls the reception and manipulation of input data, and the output and display of data on output devices (e.g., display 1018).

Processor 1002 is coupled bi-directionally with memory 1010, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1002. Also as is well known in the art, primary storage typically includes basic operating instructions, program code, data, and objects used by the processor 1002 to perform its functions (e.g., programmed instructions). For example, memory 1010 can include any suitable computer-readable storage media, described below, depending on whether, for example, data access needs to be bi-directional or uni-directional. For example, processor 1002 can also directly and very rapidly retrieve and store frequently needed data in a cache memory (not shown).

A removable mass storage device 1012 provides additional data storage capacity for the computer system 1000, and is coupled either bi-directionally (read/write) or uni-directionally (read only) to processor 1002. For example, storage 1012 can also include computer-readable media such as magnetic tape, flash memory, PC-CARDS, portable mass storage devices, holographic storage devices, and other storage devices. A fixed mass storage 1020 can also, for example, provide additional data storage capacity. The most common example of mass storage 1020 is a hard disk drive. Mass storage 1012, 1020 generally store additional programming instructions, data, and the like that typically are not in active use by the processor 1002. It will be appreciated that the information retained within mass storage 1012 and 1020 can be incorporated, if needed, in standard fashion as part of memory 1010 (e.g., RAM) as virtual memory.

In addition to providing processor 1002 access to storage subsystems, bus 1014 can also be used to provide access to other subsystems and devices. As shown, these can include a display monitor 1018, a network interface 1016, a keyboard 1004, and a pointing device 1006, as well as an auxiliary input/output device interface, a sound card, speakers, and other subsystems as needed. For example, the pointing device 1006 can be a mouse, stylus, track ball, or tablet, and is useful for interacting with a graphical user interface.

The network interface 1016 allows processor 1002 to be coupled to another computer, computer network, or telecommunications network using a network connection as shown. For example, through the network interface 1016, the processor 1002 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1002 can be used to connect the computer system 1000 to an external network and transfer data according to standard protocols. For example, various process embodiments disclosed herein can be executed on processor 1002, or can be performed across a network such as the Internet, intranet networks, or local area networks, in conjunction with a remote processor that shares a portion of the processing. Additional mass storage devices (not shown) can also be connected to processor 1002 through network interface 1016.

An auxiliary I/O device interface (not shown) can be used in conjunction with computer system 1000. The auxiliary I/O device interface can include general and customized interfaces that allow the processor 1002 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 10 is but an example of a computer system suitable for use with the various embodiments disclosed herein. Other computer systems suitable for such use can include additional or fewer subsystems. In addition, bus 1014 is illustrative of any interconnection scheme serving to link the subsystems. Other computer architectures having different configurations of subsystems can also be utilized.

The units described above can be implemented as software components executing on one or more general purpose processors, as hardware such as programmable logic devices and/or Application Specific Integrated Circuits designed to perform certain functions or a combination thereof. In some embodiments, the units can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The units may be implemented on a single device or distributed across multiple devices. The functions of the units may be merged into one another or further split into multiple sub-units.

The methods or algorithmic steps described in light of the embodiments disclosed herein can be implemented using hardware, processor-executed software units, or combinations of both. Software units can be installed in random-access memory (RAM), memory, read-only memory (ROM), electrically programmable ROM, electrically erasable programmable ROM, registers, hard drives, removable disks, CD-ROM, or any other forms of storage media known in the technical field.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
pre-storing multiple code scanning records in a database, the multiple code scanning records comprising code scanning result information and corresponding geographic location information at times of code scanning actions;
receiving a request from a current user to acquire at least some of the code scanning result information;
obtaining geographic location information of the current user;
acquiring, from the code scanning records in the database, the code scanning result information included in target code scanning records having distances from a geographic location of the current user that are less than a preset geographic distance threshold value; and
providing the code scanning result information included in the target code scanning records to the current user.

2. The method as described in claim 1, wherein:
the database is stored on a server; and
the acquiring of the code scanning result information included in the target code scanning records having distances from the geographic location of the current user that are less than the preset geographic distance threshold value comprises:
uploading the geographic location information of the current user to the server, the server including all the code scanning records in the database to look up the code scanning result information included in target code scanning records having distances from the geographic location of the current user that are less than the preset geographic distance threshold value; and
acquiring the code scanning result information included in the target code scanning records from the server.

3. The method as described in claim 1, wherein the code scanning result information included in the code scanning records of the database includes graphic code information or analytic results based on an analysis of the graphic code information.

4. The method as described in claim 1, wherein:
the code scanning records further comprise time point information corresponding to the times when users performed the code scanning actions; and
the acquiring, based on all the code scanning records in the database, of the code scanning result information included in the target code scanning records having distances from the geographic location of the current user that are less than the preset geographic distance threshold value comprises:
acquiring, from among code scanning records having distances from a current time point that are less than a preset time distance threshold value, the code scanning result information included in the target code scanning records having distances from the geographic location of the current user that are less than the preset geographic distance threshold value.

5. The method as described in claim 1, further comprising:
providing user information corresponding to the target code scanning records to the current user, wherein the code scanning records in the database comprise the user information on scanning parties corresponding to the code scanning actions.

6. The method as described in claim 1, wherein:
the code scanning records in the database comprise frequency information for each code scanning record; and
the providing of the code scanning result information included in the target code scanning records to the current user comprises:
providing code scanning result information included in higher-frequency target code scanning records to the current user.

7. The method as described in claim 1, wherein:
the code scanning records in the database comprise corresponding code scanning result category information; and
the providing of the code scanning result information included in the target code scanning records to the current user comprises:
providing, based on category information, the code scanning result information included in the target code scanning records to the current user.

8. The method as described in claim 1, further comprising:
determining a user category to which the current user belongs from the database, wherein the code scanning records in the database comprise the user category of scanning parties corresponding to the code scanning actions; and
determining which of the scanning parties corresponding to the various target code scanning records belong to the same category of user as the current user,
wherein:
the code scanning records in the database comprise user category information on the scanning parties corresponding to the code scanning actions; and
the providing of the code scanning result information included in the target code scanning records to the current user comprises:
providing, to the current user, scanning result information included in the target code scanning records corresponding to scanning parties that belong to the same category as the current user.

9. A device, comprising:
a database configured to pre-store multiple code scanning records, the multiple code scanning records including code scanning result information and corresponding geographic location information at a time of code scanning;
a request receiving unit configured to receive a request from a current user to acquire at least some of the code scanning result information;
a geographic location information obtaining unit configured to obtain geographic location information of the current user;
an information acquiring unit configured to acquire, from the code scanning records in the database, the code scanning result information included in target code scanning records having distances from a geographic location of the current user that are less than a preset geographic distance threshold value; and
an information providing unit configured to provide the code scanning result information included in the target code scanning records to the current user.

10. A device, comprising:
a detecting unit configured to obtain information on a geographic location of a current user when a code scanning action performed by the current user is detected;
an uploading unit configured to upload the code scanning result information corresponding to the code scanning action and the corresponding geographic location information to a server so that the server can store the code scanning result information and the corresponding geographic location information in code scanning records of a database;
an information acquiring unit configured to in the event that acquiring code scanning result information is required, request and acquire, based on information on the geographic location of the current user, from the server code scanning result information included in target code scanning records having distances from the current user that are less than a preset geographic distance threshold value; and
an information providing unit configured to provide the code scanning result information included in the target code scanning records to the current user.

11. A method, comprising:
collecting end user code scanning records and storing the end user code scanning records in a database, the code scanning records storing code scanning result information and corresponding geographic location information of users when performing code scanning actions;
receiving a query request sent from an inquirer client, the query request including geographic location information of the inquirer client;
acquiring, based on code scanning records stored in the database, code scanning result information included in target code scanning records having distances from a geographic location of the inquirer client that are less than a preset geographic distance threshold value; and
sending the code scanning result information included in the target code scanning records back to the inquirer client so that the inquirer client can provide the code scanning result information included in the target code scanning records to a user.

12. The method as described in claim 11, further comprising:
storing, in the code scanning records, time point information for times when corresponding users perform the code scanning actions.

13. The method as described in claim 11, further comprises:
acquiring expiration times for all code scanning records; and
in the event that a code scanning record reaches a corresponding expiration time, deleting the code scanning record from the database.

14. The method as described in claim 11, further comprising:
determining whether a new code scanning result information and corresponding geographic location information are received;
in the event that the new code scanning result information and corresponding geographic location information are received, determining whether the existing code scanning records in the database already include the code scanning result information and corresponding geographic location information, wherein the code scanning records in the database comprise a frequency field; and
in the event that the existing code scanning records in the database already include the code scanning result information and corresponding geographic location information:
merging the code scanning result information and corresponding geographic location information with the existing code scanning record; and
adding one to a value of the frequency field in the existing code scanning record.

15. The method as described in claim 11, further comprising:
determining category information of the code scanning result information included in the code scanning records; and
storing the category information to the code scanning records.

16. The method as described in claim 11, further comprising:
determining user category information of scanning parties included in the code scanning records; and
storing the user category information to the code scanning records.

17. A device, comprising:
a collecting unit configured to collect end user code scanning records and store the end user code scanning records in a database, the code scanning records storing correspondences between code scanning result information and geographic location information of users when performing code scanning actions;
a request receiving unit configured to receive a query request sent from an inquirer client, the query request including information on a geographic location of the inquirer client;
a looking up unit configured to acquire, based on code scanning records stored in the database, code scanning result information included in target code scanning records having distances from the geographic location of the inquirer client that are less than a preset geographic distance threshold value; and
an information returning unit configured to send the code scanning result information included in the target code scanning records back to the inquirer client so that the inquirer client can provide the code scanning result information included in the target code scanning records to a user.
